(19) United States
(12) Patent Application Publication
(10) Pub. No.: US 2008/0310830 A1
(43) Pub. Date: Dec. 18, 2008

(54) IMAGE TAKING APPARATUS AND IMAGE TAKING METHOD

(75) Inventors: Yi Pan, Miyagi (JP); Kenichiro Ayaki, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/138,121

(22) Filed: Jun. 12, 2008

(30) Foreign Application Priority Data
Jun. 13, 2007 (JP) 2007-156467

(51) Int. Cl. G03B 17/00

(52) U.S. Cl. 396/52

(57) ABSTRACT

The power consumption is reduced by efficiently using C-AF (continuous autofocus). An angular velocity detection circuit calculates angular velocity based on output from a yaw direction angular velocity sensor and a pitch direction angular velocity sensor. Based on the angular velocity, a shake width detection circuit 45 continuously detects the shake amount of the apparatus. If the maximum value of the shake amount during the latest Nms (N milli-seconds) is less than a pre-determined value, it is judged to be a time for shooting operation and the C-AF is operated. If the maximum value of the shake width during the latest Nms is the pre-determined amount or more, it is judged that shooting operation is not being performed and the C-AF is stopped. In this manner, the power consumption can be reduced by operating the C-AF only as needed.

### BACKGROUND OF THE INVENTION

1. Field of the Invention

The present invention relates to an image taking apparatus and an image taking method, and particularly to an image taking apparatus and an image taking method which detect camera shakes and control operation or non-operation of continuous AF.

2. Description of the Related Art

As an autofocus (AF) camera such as a digital camera, a camera is known which can switch between two modes of a so-called single AF mode (S-AF mode) to perform AF operation only if a release button is pressed halfway and retain the focusing state till the half pressing is cancelled after the camera once focused, and a so-called continuous AF mode (C-AF mode) to always perform the AF operation continually and repeatedly irrespective of the half pressing. In the C-AF mode, when a focal point evaluation value decreases after the focusing, the AF operation is started again, a focus lens is moved by a pre-determined amount, focal point evaluation values before and after the movement are compared, the lens is moved by a pre-determined amount in a direction that an evaluation value increases, and similar processing continues. Then, such processing is repeatedly executed so that the focus lens is moved to a position where a focal point evaluation value is at its peak.

The C-AF mode is used for operation to follow a moving subject or to shorten a time lag in shooting. However, it has a drawback of high power consumption since the focusing operation is performed by always driving the focus lens, as previously discussed. To solve the drawback, Japanese Patent Application Laid-Open No. 2003-107326 discloses a camera which restarts again after once focused and changes a range of an evaluated value for the focusing operation depending on a subject or shooting conditions. The camera disclosed in Japanese Patent Application Laid-Open No. 2003-107326 can decrease the frequency to restart C-AF and depress wasted power consumption.

### SUMMARY OF THE INVENTION

However, the camera disclosed in Japanese Patent Application Laid-Open No. 2003-107326 has a drawback in that power consumption is wastefully consumed since C-AF operates when a photographer conducts camera works such as for a position, an angle or the size of a shot of a subject. In view of such circumstances, it is an object of the present invention to provide an image taking apparatus and an image taking method which can efficiently use C-AF and reduce the power consumption.

To achieve the object, a first aspect of the present invention provides an image taking apparatus comprising: an imaging device which converts a subject image of which light is received via an imaging lens into an image signal; an automatic focusing device which moves a focus lens to a focusing position based on the image signal; a control device which continuously operates the automatic focusing device; and a shake detection device which continuously detects shakes of the apparatus body, wherein the control device operates the automatic focusing device if shakes in a latest pre-determined period detected by the detection device are less than a pre-determined amount, and stops operation of the automatic focusing device if the shakes are the pre-determined amount or more.

According to the first aspect, C-AF can be used efficiently and the power consumption can be depressed.

In a second aspect of the present invention, the image taking apparatus according to the first aspect further comprises an input device through which a user can set shooting parameters, wherein the input device can set the pre-determined amount.

According to the aspect, an easy-to-use C-AF can be realized.

In a third aspect of the present invention, the image taking apparatus according to the first or second aspect is characterized in that the input device can set the pre-determined period.

According to the aspect, an easy-to-use C-AF can be realized.

To achieve the object, a fourth aspect of the present invention provides an image taking method comprising: an imaging step of converting a subject image of which light is received via an imaging lens into an image signal; an automatic focusing step of moving a focus lens to a focusing position based on the image signal; a control step of continuously operating the automatic focusing step; and a shake detection step of continuously detecting shakes of the apparatus body, wherein the control step includes operating the automatic focusing step if shakes in a latest pre-determined period detected by the detection step are less than a pre-determined amount, and stopping operation of the automatic focusing step if the shakes are the pre-determined amount or more.

According to the aspect, the C-AF can be used efficiently and the power consumption can be depressed.

According to the present invention, the amount of camera shakes is detected and operation or non-operation of the C-AF is controlled, so that an image taking apparatus and an image taking method can be provided which can efficiently use C-AF and reduce the power consumption.

### BRIEF DESCRIPTION OF THE DRAWINGS

FIG. 1 is a block diagram showing the electric configuration according to a first embodiment of a digital camera to which the present invention is applied;

FIG. 2 is a block diagram showing a camera shake compensation control unit 17 and its peripheral part;

FIG. 3 is a flowchart illustrating AF operation in a digital camera 10;

FIGS. 4A and 4B are diagrams showing an example of output of a pitch direction angular velocity sensor 43 and a yaw direction angular velocity sensor 42;

FIGS. 5A and 5B are diagrams showing an example of output of the pitch direction angular velocity sensor 43 and the yaw direction angular velocity sensor 42; and

FIGS. 6A and 6B are diagrams showing an example of output of the pitch direction angular velocity sensor 43 and the yaw direction angular velocity sensor 42.

### DETAILED DESCRIPTION OF THE PREFERRED EMBODIMENTS

The following will describe the best embodiment to carry out the present invention with reference to the attached drawings.

### First Embodiment

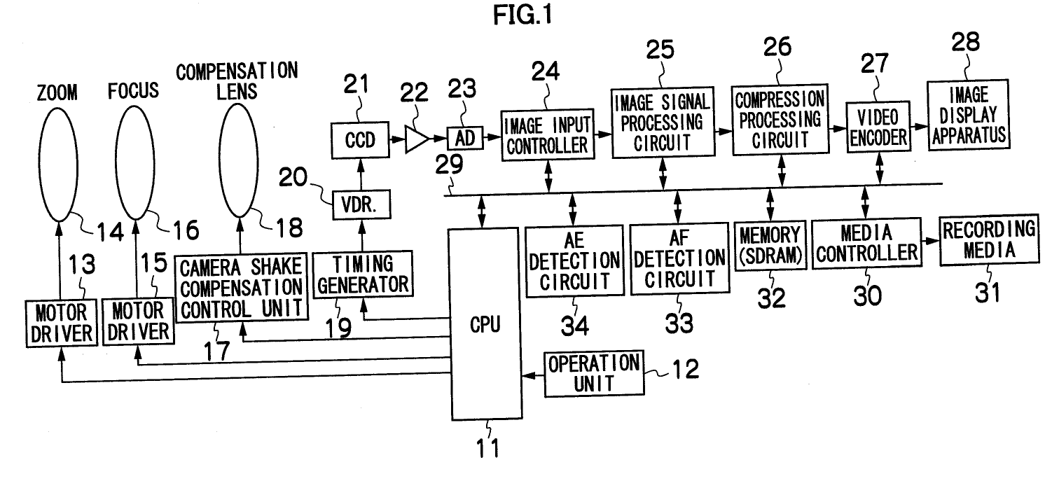

FIG. 1 is a block diagram showing the electric configuration according to a first embodiment of a digital camera to which the present invention is applied.

As shown in FIG. 1, a digital camera 10 according to this embodiment comprises a CPU 11, an operation unit 12, a zoom lens motor driver 13, a zoom lens 14, a focus lens motor driver 15, a focus lens 16, a camera shake compensation control unit 17, a camera shake compensation lens 18, a timing generator 19, a CCD driver 20, a CCD image sensor 21, an analog signal processing unit 22, an A/D converter 23, an image input controller 24, an image signal processing circuit 25, a compression processing circuit 26, a video encoder 27, an image display apparatus 28, a bus 29, a media controller 30, a recording media 31, a memory (SDRAM) 32, an AF detection circuit 33, an AE detection circuit 34 and the like.

The respective units operate through control by the CPU 11. The CPU 11 controls the respective units of the digital camera 10 by executing pre-determined control programs based on input from the operation unit 12.

The CPU 11 includes a built-in program ROM. In the program ROM, the control programs executed by the CPU 11 and various types of data needed to the control are recorded. The CPU 11 reads out the control programs recorded in the program ROM to the memory 32 and serially executes the programs to control the respective units of the digital camera 10.

The memory 32 is used as an execution processing area for a program and used as a temporal storage area for image data or the like and various types of work areas.

The operation unit 12 includes general operating devices of a camera such as a power switch, a release button, a shooting mode dial, a camera shake compensation switch and the like. It outputs a signal appropriate for operation to the CPU 11.

The focus lens 16 is driven by the focus lens motor driver 15 to move back and forth on an optical axis of the zoom lens 14. The CPU 11 conducts focusing by controlling movement of the focus lens 16 via the focus lens motor driver 15.

The zoom lens 14 is driven by the zoom lens motor driver 13 to move back and forth on an optical axis of the focus lens 16. The CPU 11 conducts zooming by controlling movement of the zoom lens 14 via the zoom lens motor driver 13.

The camera shake compensation lens 18 is controlled by the camera shake compensation control unit 17 to cancel camera shakes in two mutually orthogonal directions on the lens surface, compensates camera shakes for a subject image via the zoom lens 14 and the focus lens 16, and transmits the subject image subjected to the camera shake compensation across the CCD image sensor 21.

The CCD image sensor 21 (hereinafter referred as “CCD 21”), which is placed on a rear stage of the camera shake compensation lens 18, receives subject light that transmitted the camera shake compensation lens 18. The CCD 21 comprises an acceptance surface on which many light receiving elements are arranged in a matrix, as well known. The subject light that transmitted the camera shake compensation lens 18 is formed into an image on the acceptance surface of the CCD 21 and converted into an electric signal by each of the light receiving elements.

The CCD 21 outputs a line of electric charges accumulated in each pixel as a serial image signal in synchronization with a vertical transfer clock and a horizontal transfer clock that are supplied from the timing generator 19 via the CCD driver 20. The CPU 11 controls driving of the CCD 21 by controlling the timing generator 19.

The electric charge accumulation time (exposure time) of each pixel is decided by an electronic shutter drive signal given by the timing generator 19. The CPU 11 indicates the electric charge accumulation time to the timing generator 19.

The output of an image signal is started when the digital camera 10 is set to a shooting mode. That is, when the digital camera 10 is set to the shooting mode, the output of an image signal is started to display a through-the-lens image on the image display apparatus 28. The output of an image signal for a through-the-lens image is once stopped if the shooting is directed; it is again started if the shooting finishes.

An image signal outputted from the CCD 21 is an analog signal. The analog image signal is captured by the analog signal processing unit 22.

The analog signal processing unit 22 includes a correlated double sampling circuit (CDS) and an automatic gain control circuit (AGC). A CDS removes noises contained in an image signal, while an AGC amplifies a denoised image signal with a pre-determined gain. An analog image signal subjected to required signal processing by the analog signal processing unit 22 is captured by the A/D converter 23.

The A/D converter 23 converts the captured analog image signal into a digital image signal with a pre-determined bit gray scale range. The image signal, being so-called RAW data, has a gray scale value indicating R, G and B densities for each pixel.

The image input controller 24, which includes a pre-determined capacity of built-in line buffer, accumulates image signals for a single image outputted from the A/D converter 23. The image signals for a single image accumulated by the image input controller 24 are stored in the memory 32 via the bus 29.

The bus 29 connects to the CPU 11, the memory 32, the image input controller 24, the image signal processing circuit 25, the compression processing circuit 26, the video encoder 27, the media controller 30, the AF detection circuit 33, the AE detection circuit 34 and the like in the above, which can transmit/receive information to/from each other via the bus 29.

The image signals for a single image stored in the memory 32 are captured by the image signal processing circuit 25 dot-sequentially (in the pixel order).

The image signal processing circuit 25 performs pre-determined signal processing on each of the image signals in each of R, G and B colors captured dot-sequentially to generate an image signal (Y/C signal) consisting of a luminance signal Y and color difference signals Cr and Cb.

The AF detection circuit 33 captures the R, G and B image signals stored in the memory 32 via the image input controller 24 and calculates a focal point evaluation value necessary for the AF (Automatic Focus) control according to an instruction by the CPU 11. The AF detection circuit 33, which includes a high-pass filter for passing through only a high-frequency component of a G signal, an absolution processing unit, a focus area extraction unit for getting out a signal in a pre-determined focus area being set on a screen, and an integration unit for integrating absolute value data in the focus area, outputs the absolute value data in the focus area integrated by the integration unit as a focal point evaluation value to the CPU 11. During the AF control, the CPU 11 searches for a position at which a focal point evaluation value outputted from the AF detection circuit 33 becomes the local maximum, and moves the focus lens 16 to the position to focus on a main subject.

The AE detection circuit 34 captures the R, G and B image signals stored in the memory 32 via the image input controller 24 and calculates an integration value necessary for the AE control according to an instruction by the CPU 11. The CPU 11 calculates a luminance value from the integration value and obtains an exposure value from the luminance value. It also decides a diaphragm value and a shutter speed from the exposure value according to a pre-determined program chart.

The compression processing circuit 26 performs compression processing in a pre-determined format (for example, JPEG) on the image signal (Y/C signal) consisting of the inputted luminance signal Y and the color difference signals Cr and Cb to generate compressed image data according to a compression instruction by the CPU 11. It also performs expansion processing in a pre-determined format on the inputted compression image data to generate uncompressed image data according to an expansion instruction by the CPU 11.

The video encoder 27 controls display on the image display apparatus 28 according to an instruction by the CPU 11.

The media controller 30 controls read/write of data from/to the recording media 31 according to an instruction by the CPU 11. The recording media 31 can be attached/detached to/from the camera body such as a memory card, or built in the camera body. If the media 31 can be attached/detached to/from the body, then the camera body is provided with a card slot and the media 31 is used with being loaded in the card slot.

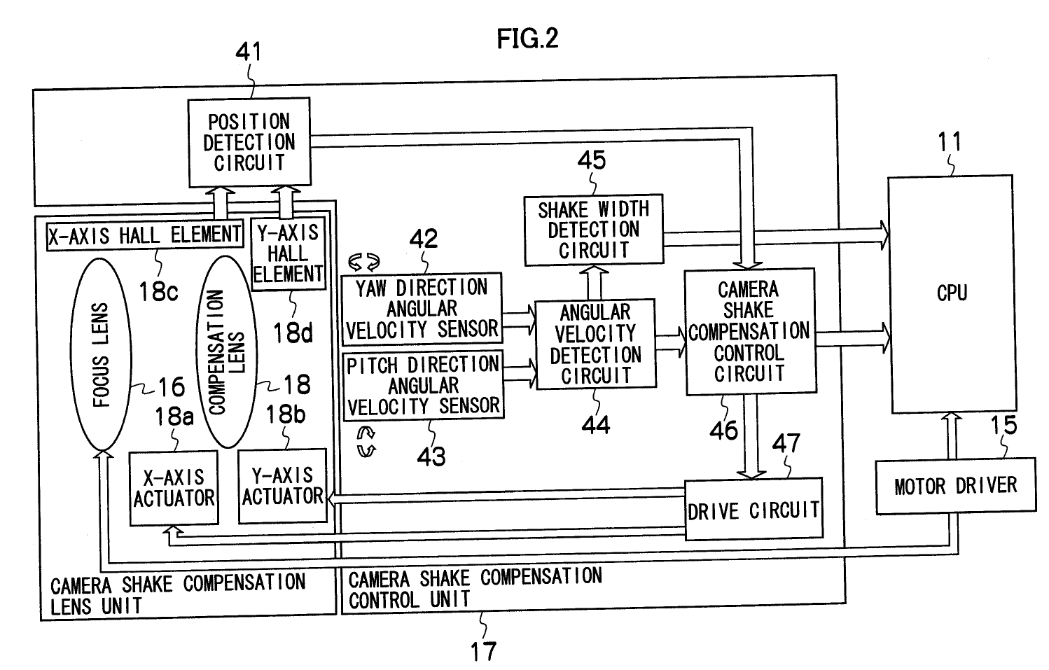

Next, the camera shake compensation control unit 17 will be described. FIG. 2 is a block diagram showing the camera shake compensation control unit 17 and its peripheral part.

The camera shake compensation control unit 17 includes a position detection circuit 41, a yaw direction angular velocity sensor 42, a pitch direction angular velocity sensor 43, an angular velocity detection circuit 44, a shake width detection circuit 45, a camera shake compensation control circuit 46 and a drive circuit 47. The camera shake compensation lens 18 comprises an X-axis actuator 18a and a Y-axis actuator 18b which move the camera shake compensation lens 18, and an X-axis hall element 18c and a Y-axis hall element 18d which detect a position of the camera shake compensation lens 18.

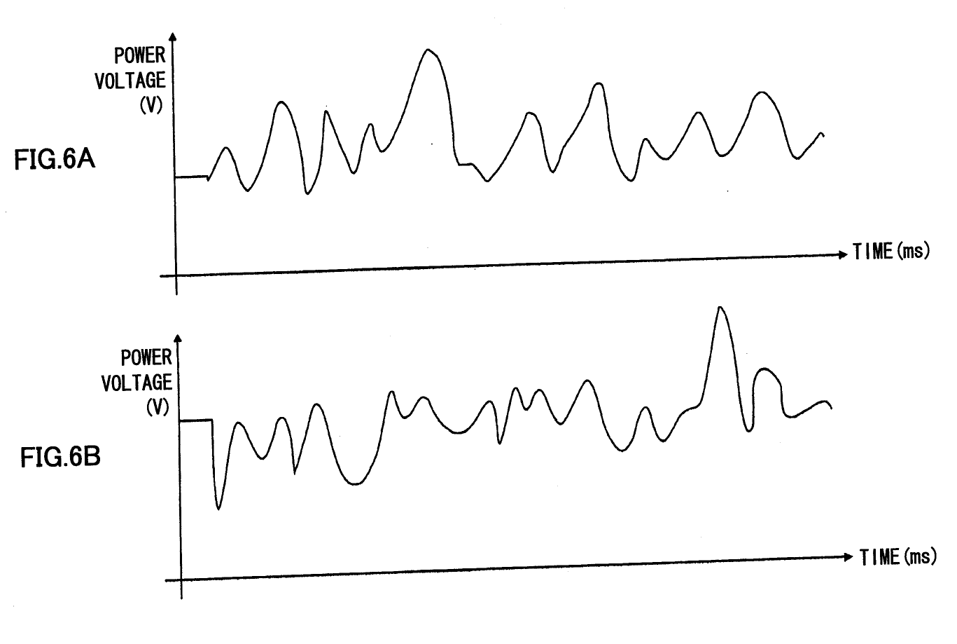

The angular velocity detection circuit 44 continuously detects angular velocity of the digital camera 10 based on output from the yaw direction angular velocity sensor 42 and the pitch direction angular velocity sensor 43. FIG. 6A is a diagram showing an example of the output from the pitch direction angular velocity sensor 43, while FIG. 6B is a diagram showing an example of the output from the yaw direction angular velocity sensor 42. As shown, an angular velocity sensor outputs a certain direct bias voltage while it is static. When the sensor rotates, direct voltage appropriate for the angular velocity is applied to the bias voltage and outputted. The angular velocity detection circuit 44 calculates angular velocity based on the sensor output in two directions.

The camera shake compensation control circuit 46 can drive the X-axis actuator 18a and the Y-axis actuator 18b via the drive circuit 47 to move the camera shake compensation lens 18. Meanwhile, the position detection circuit 41 can detect a position of the camera shake compensation lens 18 based on output from the X-axis hall element 18c and the Y-axis hall element 18d. The camera shake compensation control circuit 46 moves the camera shake compensation lens 18 by a control amount appropriate for angular velocity calculated by the angular velocity detection circuit 44 based on the position information outputted from the position detection circuit 41 for camera shake compensation.

During the above compensation, the shake width detection circuit 45 monitors a variation amount of the angular velocity calculated by the angular velocity detection circuit 44 and outputs the shake amount to the CPU 11. The CPU 11 controls the AF operation on the focus lens 16 based on the inputted shake amount.

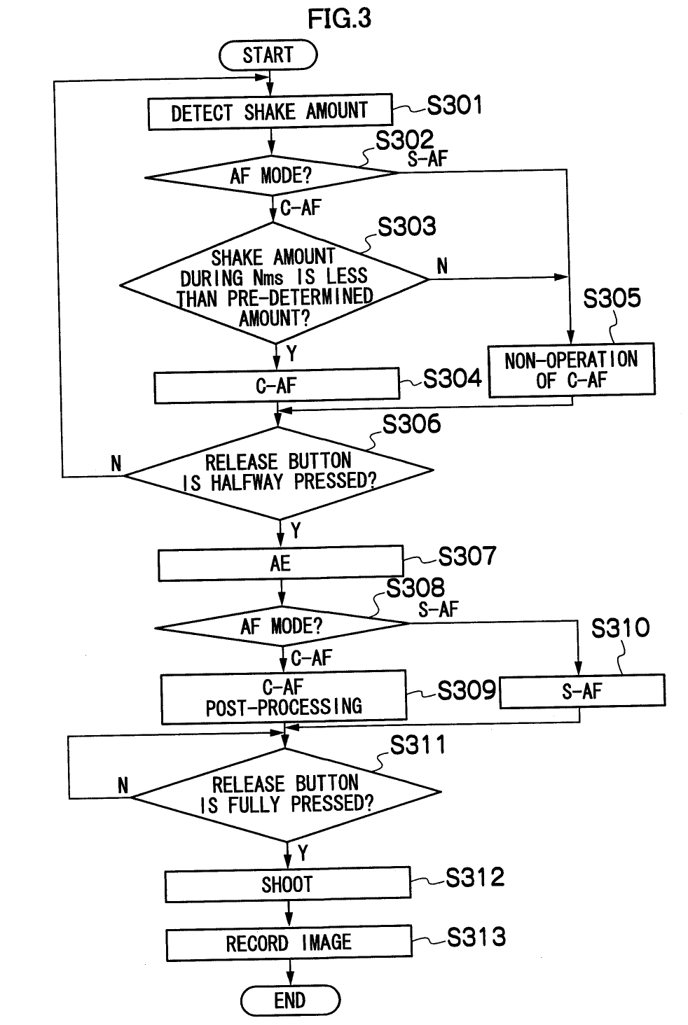

Now, the control of the AF operation based on the shake amount will be described. FIG. 3 is a flowchart illustrating the AF operation in the digital camera 10.

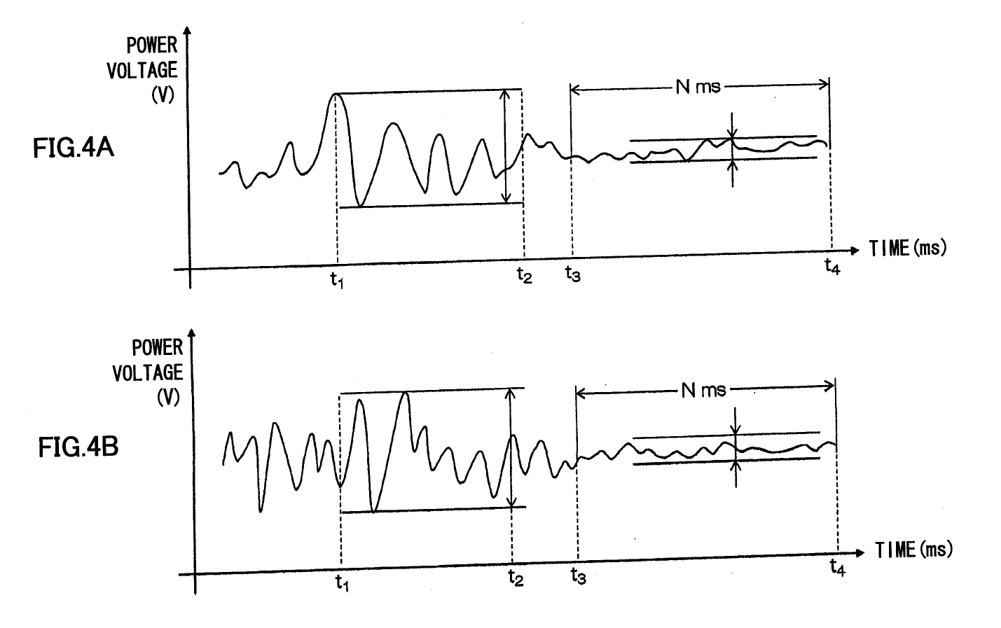

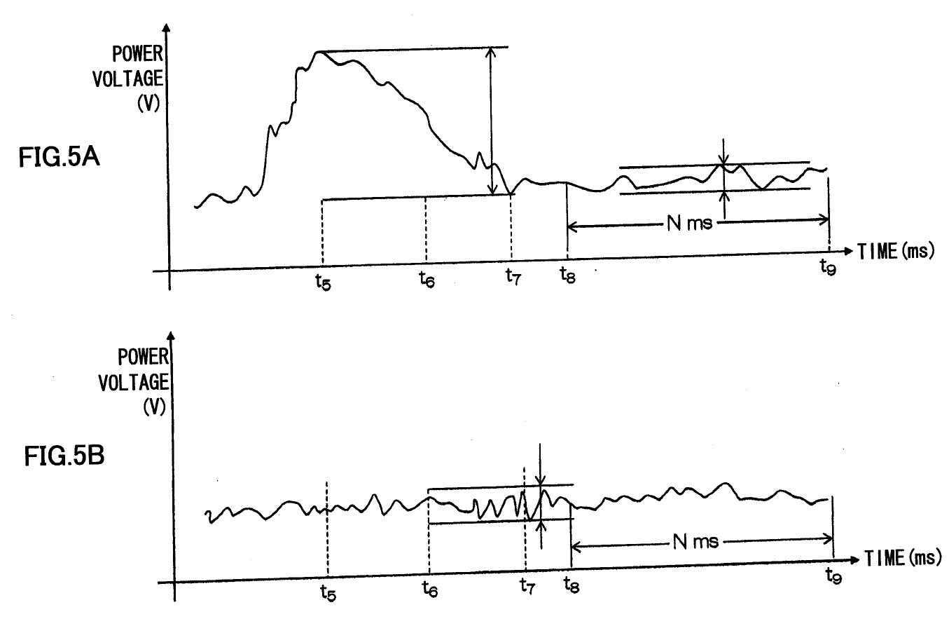

When the digital camera 10 is powered on, the amount of shakes is detected continuously (step S301). As discussed in the above, the shake width detection circuit 45 monitors the variation amount of angular velocity calculated by the angular velocity detection circuit 44 and outputs the shake amount to the CPU 11. Next, determination is made on an AF mode (step S302). The digital camera 10 according to the present invention has two AF modes of S-AF and C-AF which can be selected by a photographer through the operation unit 12. If the camera 10 is set to the S-AF mode, then determination is not made on a detected shake amount, the flow proceeds to step S305, and the C-AF is not operated. If the camera 10 is set to the C-AF mode, it is determined whether or not the maximum value of the shake amount detected at step S301 is less than a pre-determined amount in the latest Nms (N milli-seconds) (step S303). If it is determined that the maximum value of the shake amount is less than the pre-determined amount in the latest Nms, the C-AF operation is performed (step S304); if it is determined that the maximum value of the shake amount is the pre-determined amount or more, the C-AF is not operated. With reference to FIGS. 4 and 5, detection of the shake amount and C-AF control will be described.

FIG. 4A is a diagram showing an example of the output from the pitch direction angular velocity sensor 43, while FIG. 4B is a diagram showing an example of the output from the yaw direction angular velocity sensor 42. It can be seen that from time t₁ to time t₂ in the drawing is an unstable state in that angular velocity changes largely in both a pitch direction and a yaw direction. In this state, shooting operation is not performed, for example, a photographer holds the digital camera 10 in one hand. Between time t₃ and time t₄, angular velocity changes a little in both a pitch direction and a yaw direction and the state continues for Nms. In this state, a photographer holds the digital camera 10 for the shooting operation.

Similarly to the above, FIG. 5A is a diagram showing an example of the output from the pitch direction angular velocity sensor 43, while FIG. 5B is a diagram showing an example of the output from the yaw direction angular velocity sensor 42. In the state between time t₅ and time t₇, angular velocity changes largely in a pitch direction and a photographer is tilting the digital camera 10. On the other hand, in the state between time t₆ and time t₈, angular velocity changes largely in a yaw direction and a photographer panning the digital camera 10. In these states, a photographer is searching for the angle. Afterward, between time t₈ and time t₉, angular velocity changes a little in both a pitch direction and a yaw direction and the state continues for Nms. In this state, a photographer holds the digital camera 10 for the shooting operation.

As can be seen in the above, the amplitude of an output signal of an angular velocity sensor is high when a photographer conducts camera work, the amplitude of an output signal of the angular velocity sensor is low when the camera work is finished. As such, it is possible to anticipate timing of the shooting operation by monitoring the shake amount using the angular velocity sensor. In the C-AF mode of the digital camera 10 according to this embodiment, the C-AF operation is performed at the time that is anticipated to be timing of the shooting operation. That is, the C-AF is operated only if GyroW_{Nms≦}GyroW_{—Thresh} is satisfied when the width of an output level of the angular velocity sensor during the latest Nms is GyroW_{Nms} and a threshold of the C-AF operation is GyroW_{—Thresh}. If the condition is not satisfied, the C-AF operation is not performed.

Next, it is determined whether or not a release button of the operation unit 12 is pressed halfway (step S306). If the release button is not pressed halfway, the flow returns to step S301.

If the release button is pressed halfway, the CPU 11 operates the AE detection circuit 34, and decides a diaphragm value and a shutter speed from an obtained exposure value (step S307). Next, determination is made on the AF mode. If a mode is set to S-AF, the focus is locked (step S310). If the mode is set to C-AF, the focusing operation is continued based on information before the release button is pressed halfway (step S309).

Afterward, when the release button is fully pressed (step S311), the shooting is performed (step S312), and an image being taken is recorded in the recording media 31 (step S313).

As described in the above, the shake amount is calculated from the angular velocity sensor and the C-AF is controlled based on the calculated shake amount so that wasteful C-AF operation can be limited and the power consumption can be reduced.

In this embodiment, the C-AF operation is performed if the shake amount in the latest pre-determined period (during Nms) is less than a pre-determined amount (GyroW_{—Thresh}). However, Nms being a threshold at that time can be a value being previously set in the digital camera 10, or can be set by a photographer through the operation unit 12. Similarly, GyroW_{—Thresh} being a threshold of the shake amount can be a value being previously set in the digital camera 10, or can be set by a photographer through the operation unit 12.

In this embodiment, the C-AF is operated while output from both of the yaw direction angular velocity sensor 42 and the pitch direction angular velocity sensor 43 is stable. However, the C-AF can be operated while output from one of the yaw direction angular velocity sensor 42 and the pitch direction angular velocity sensor 43 is stable.

What is claimed is:

1. An image taking apparatus comprising:
an imaging device which converts a subject image of which light is received via an imaging lens into an image signal;
an automatic focusing device which moves a focus lens to a focusing position based on the image signal;
a control device which continuously operates the automatic focusing device; and
a shake detection device which continuously detects shakes of the apparatus body,
wherein the control device operates the automatic focusing device if shakes in a latest pre-determined period detected by the detection device are less than a pre-determined amount, and stops operation of the automatic focusing device if the shakes are the pre-determined amount or more.

2. The image taking apparatus according to claim 1, further comprising an input device through which a user can set shooting parameters, wherein the input device can set the pre-determined amount.

3. The image taking apparatus according to claim 1, wherein the input device can set the pre-determined period.

4. The image taking apparatus according to claim 2, wherein the input device can set the predetermined period.

5. An image taking method comprising:
an imaging step of converting a subject image of which light is received via an imaging lens into an image signal;
an automatic focusing step of moving a focus lens to a focusing position based on the image signal;
a control step of continuously operating the automatic focusing step; and
a shake detection step of continuously detecting shakes of the apparatus body,
wherein the control step includes operating the automatic focusing step if shakes in a latest pre-determined period detected by the detection step are less than a pre-determined amount, and stopping operation of the automatic focusing step if the shakes are the pre-determined amount or more.
